(19) United States
(12) Patent Application Publication
(10) Pub. No.: US 2021/0345789 A1
(43) Pub. Date: Nov. 11, 2021

(54) MATTRESS WITH EXPANSIBLE SIDES

(71) Applicant: Horacio C. Rubio, Robstown, TX (US)

(72) Inventor: Horacio C. Rubio, Robstown, TX (US)

(21) Appl. No.: 17/245,155

(22) Filed: Apr. 30, 2021

Related U.S. Application Data
(60) Provisional application No. 63/101,626, filed on May 7, 2020.

(51) Int. Cl. A47C 21/08

(52) U.S. Cl. CPC A47C 21/08

(57) ABSTRACT

A mattress includes pairs of side rails having an expandable section for increasing the side support of a user. The expandable section may be inflatable or receive an insert. The structural strength of the side rails may alternately support the user and collapse to allow the user to be easily lifted over the side rail. In open cell foam embodiments, this is accomplished by installing or removing an interior support. In inflatable embodiments, this is accomplished by inflating or deflating expandable compartments.

### BACKGROUND OF THE INVENTION

There are beds or mattresses that support a person in a supine, inclined or reclining fashion. Many of these include side rails for limiting movement by the user. A typical disclosure is found in U.S. Pat. No. 7,415,743 of which this invention is an improvement and the disclosure of which is incorporated herein by reference.

### SUMMARY OF THE INVENTION

Prior art mattresses are not sufficiently supportive for children or adults needing extra side support, such as people with cerebral palsy, hydrocephalus and spina bifida. Post surgical patients and patients undergoing therapy may also benefit from increased side support during bed rest. A typical approach is for a healthcare worker to place multiple standard pillows against the patient in an attempt to keep the patient on his/her side. The result is not consistently favorable because pillows shift, move, collapse or otherwise act to provide less than adequate support.

In some embodiments, the concept of this disclosure is the provision of sections in sides of a mattress that can be expanded in any suitable manner, as by inflating a compartment or placing an insert in pockets in the mattress. An important advantage of a mattress of this construction is the user continues to have leg and arm movement.

One difficulty with mattresses of this type is lifting an adult or teenager off the mattress, as when the user needs to be moved for any reason. In some open cell foam embodiments, the structural strength of a side rail is reduced by removing an insert in the side rail and thereby allowing the side rail to at least partially collapse so the patient does not have to be lifted over the full height of the side rail. In some embodiments, the side rail may be an inflated structure providing sufficient strength for the purpose and deflated to at least partially collapse and allow easy movement of the user.

It is an object of this invention to provide an improved mattress.

Another object of this invention is to provide a mattress providing an inclined body support surface having improved adjustable side supports.

Another object of this invention is to provide help to a convalescent user by providing an improved side support mattress.

A further object of this invention is to provide a mattress having a side rail that may be collapsed to allow movement of the user across the side rail without undue effort.

These and other objects and advantages of this invention will become more fully apparent as this description proceeds.

### BRIEF DESCRIPTION OF THE DRAWINGS

FIG. 1 is an expanded isometric view of one embodiment of a mattress having expandable side sections;

FIG. 2 is a cross-sectional view of the mattress of FIG. 1 taken along line 2-2 as viewed in the direction indicated by the arrows;

FIG. 3 is an expanded partial isometric view of a foam mattress illustrating one technique changing the structural strength of a side rail of a mattress, certain parts being broken away for clarity of illustration;

FIG. 4 is a partial isometric view of the foam mattress of FIG. 3 illustrating a partially collapsed configuration of a side rail;

FIG. 5 is a cross-sectional view, similar to FIG. 2, showing a second embodiment of a mattress allowing the placement of wedge shaped inserts in pockets in the mattress;

FIG. 6 is a schematic view of an enlarged expandable compartment assembly particularly adapted for use in medium or large sized mattresses;

FIG. 7 is a schematic view of a control system for inflating expandable compartments in side rails of a mattress; FIG. 8 is an expanded partial isometric view of a foam mattress illustrating one technique changing the structural strength of a side rail of a mattress;

FIG. 9 is a partial isometric view of the foam mattress of FIG. 8 illustrating a partially collapsed configuration of a side rail and part of the mattress body;

FIGS. 10 and 11 are partial isometric views of a mattress illustrating another technique for changing the structural strength of a side rail; and

FIG. 12 is a partial isometric view illustrating a mattress made of inflatable compartments, mimicking operation of open cell foam embodiments.

### DETAILED DESCRIPTION OF THE INVENTION

In one sense, the device of this invention may be considered a mattress. In another sense, it may be considered a bed. Both terms are used herein.

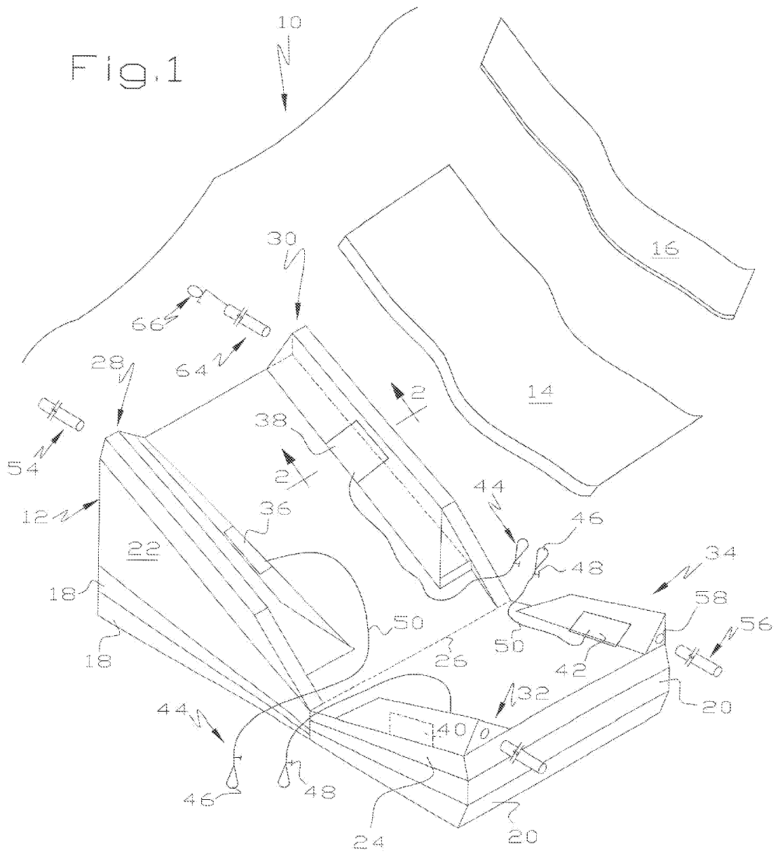

Referring to FIG. 1, a mattress 10 comprises, as major components, a body support or base 12, a cover layer 14 and a flexible cover 16. The base 12 may be of any suitable configuration and may preferably comprise a structure similar to that shown in U.S. Pat. No. 7,415,743, such as one or more unattached wedge shaped sections 18 comprising part of a torso section and one or more unattached wedge shaped sections 20 comprising part of a foot section. A large torso wedge section 22 is fixed to a leg or foot wedge section 24, as by gluing along a joint line 26. The mattress 10 may be made of any suitable material such an open cell flexible polyurethane or other polymeric foam such as is available from Carpenter Co. of Richman, Va.

The base 12 also includes a pair of head or torso side rails or supports 28, 30 and a pair of foot side rails or supports 32, 34. The side rails 28, 30, 32, 34 may be of any suitable shape, such as rectangular, triangular, other polygonal shapes or curved so long as they provide support for the user. In some embodiments, the side rails 28, 30, 32, 34 may include an inclined side wall. The side rails 28, 30, 32, 34 may be more-or-less permanent and may be integral with the foot and head sections 22, 24 or may be fixedly attached thereto in some way, as with VELCRO fasteners or the like. As so far described, the bed 10 is substantially the same as that shown in U.S. Pat. No. 7,415,743 except for the addition of the foot rails 32, 34.

To provide an adjustable side support for a user, an expansible device is used as a supplement to the side supports 26, 28, 30, 32. In FIGS. 1-2, an inflatable compartment or bladder 36, 38, 40, 42 may be placed in or abutting an inclined side wall of each rail 28, 30, 32, 34. The bladders 36, 38, 40, 42 may be of any suitable construction. An inside surface of the bladders 36, 38, 40, 42 may be glued or otherwise secured to the its rail 28, 30, 32, 34 as in FIG. 2 or the inclined wall of the side rails 28, 30, 32, 34 may be made impermeable in some manner to captivate an expansive fluid. The bladders may advantageously be long enough to support a significant fraction of the user's body but need not be the entire length of their adjacent side rails. If properly positioned, the bladders may be on the order of 15% of the length of the associated side rail as shown in FIG. 1 but may be of any suitable length.

A source of pressure 44 may be connected to each of the compartments 36, 38, 40, 42 for selectively expanding any one or any combination of the compartments 36, 38, 40, 42. The pressure source 44 may be of any suitable type, such as a low pressure air compressor, a CO₂ bottle or the like. One convenient pressure source is shown in FIG. 1 as comprising a series of blood pressure cuff type squeezable bulbs 46 and bleed off valves 48 and conduits 50. This type pressure source is sufficient to expand the bladders 36, 38, 40, 42 and is commercially available from Calculated Industries of Carson City, Nev. The conduits 50 and may be placed on or within the mattress 10 in a suitable manner. FIG. 2 is a cross-sectional view showing partial expansion of the bladder 38.

A satisfactory way to hide the conduits 50 and bladders 36, 38, 40, 42 and smooth out the contours of the mattress 10 is by the provision of the cover 14 which may be an open cell foam sheet of sufficient thickness for these purposes. In practice a two inch thick open cell foam sheet has proved well adapted for this purpose. The mattress 10 may be enclosed in an encapsulating envelope or bag 16 of any suitable material such as sheet vinyl or a suitable fabric which may be removed and washed as necessary.

Infants or small children can readily be picked up from the bed 10 without undue strain. However, as a user matures and becomes heavier, this becomes an increasing problem. In embodiments intended for heavier users, it may be preferable to provide collapsible side rails to reduce the vertical height that a user must be lifted.

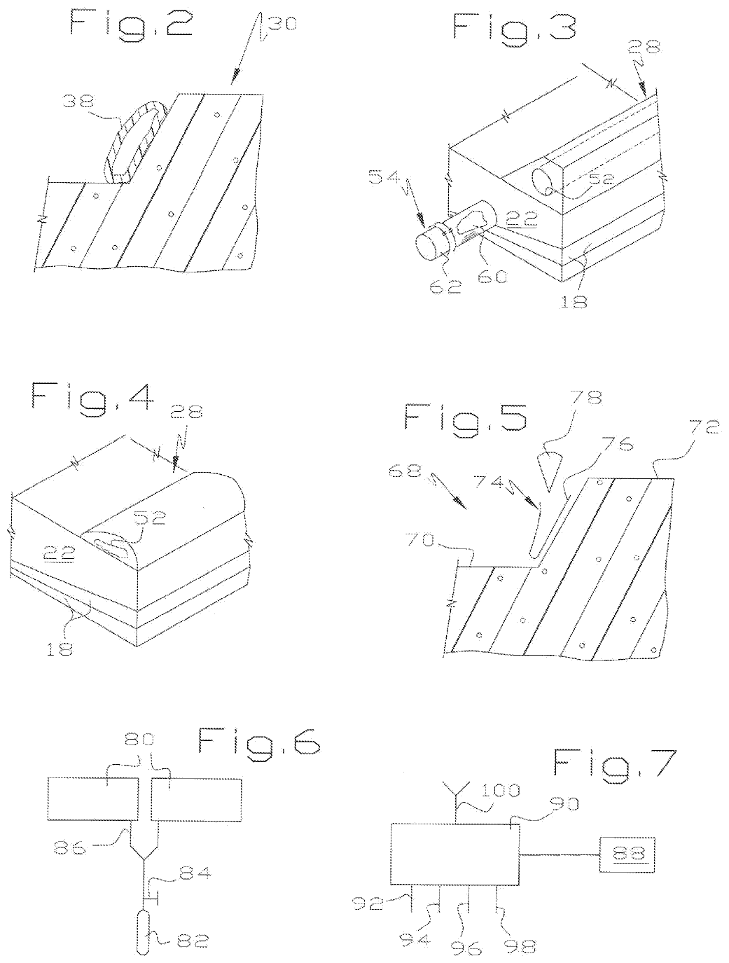

This feature is shown in FIGS. 1, 3 and 4 where the side rails 28, 30, 32, 34 have a load supporting configuration shown in FIGS. 1 and 3 and a partly collapsed configuration shown in FIG. 4 where it is easier to lift a user off the bed 10. This may be accomplished by providing a passage 52 extending along a substantial distance of the side rails 28 and a removable insert 54 configured to fill the passage 52 and produce a side rail having essentially the strength of a side rail of the same material with no passage. It will be seen that removal of the insert 54 from the passage 52 causes the rail 28 to collapse or partly collapse as shown in FIG. 4. It will be apparent that mattresses 10 may be made to include collapsible foot rails 32, 34 as shown in FIG. 1 where an insert 56 is inserted and removed from passages 58 the foot rails 32, 34. It will also be apparent that mattresses 10 may be made with collapsible side rails on only one side of a mattress if it is designed to be placed against a wall. The passage 52 may be of a length sufficient to collapse enough of the side rail 28 to allow a teenager or adult to be lifted easily out of the bed 10. The passage 52 may accordingly be at least half the length of the side rail 28, may preferably be at least three quarters of the length of the side rail 28 and may ideally open through the opposite end of the side rail 28. This is not disadvantageous because the side rail 28 and the rest of the bed 10 is covered by the foam sheet 14.

As shown in FIGS. 1 and 3, some of the inserts 54 may include a core 60 of open foam material and a sleeve 62 of slick material facilitating insertion and removal of the insert 54 from the passage 52. The sleeve 62 accordingly may have a coefficient of friction less than the foam core 60. Some of the inserts may be of an inflatable sleeve 64 as shown in FIG. 1 having a source of pressure 66 such as a squeezable bulb/valve assembly similar to the pressure sources 44.

The mattress 10 elevates the user while supporting the body in the torso area and in the leg area by the use of the permanently fixed side rails 28, 30, 32, 34 and the inflatable compartments 38, 40, 42,44 as shown in FIG. 1. The side torso and leg compartments are placed to support the user's limbs and body in accordance with the need of the particular patient to provide comfort and therapeutic support. If the user is small or possibly disabled, the use of the supplementary side support may give a sense of security and help in positioning the patient for better health.

Referring to FIG. 5, a mattress 68 provides a tapered head or foot section 70 and a rail or side section 72, similar to the mattress 10. Instead of an inflatable bladder, the mattress 68 includes a pocket 74 having an inside 76 glued or otherwise secured to the side rails in a position analogous to the location of the inflatable bladders, only one rail 72 being illustrated. The pocket 74 may be securely closed, as by VELCRO, snaps, zippers or the like. With the pocket 74 open, an insert 78 of any suitable shape and material may be placed in the pocket 74 which may then be reclosed. One suitable shape for the insert 78 is a wedge. It will be seen that the insert 78 acts in much the same manner as one of the bladders.

In larger size embodiments, such as for teenagers and adults, it may be that the bladders commercially available are too small for the purpose. In this situation, a pair of bladders 80 may be used and connected to a single source of pressure such as a squeezable bulb 82 and valve 84 connected by conduits 86 to the bladders 80 as shown in FIG. 6.

In lieu of individual pressure sources shown in FIG. 1, it may be preferred to provide a single source of pressure 88 connected to a manifold 90 having a series of valves (not shown) connecting the pressure source 88 to a series of outlet conduits 92, 94, 96, 98 which connect to the separate bladders of FIG. 1. Operation of the valves connects the pressure source 88 to an individual outlet conduit or to selected ones of the outlet conduits for inflating all of the bladders simultaneously, separately inflating the bladders or inflating selected ones of the bladders. Control of the valves (not shown) may be done remotely through a smartphone or other device communicating through an antenna 100.

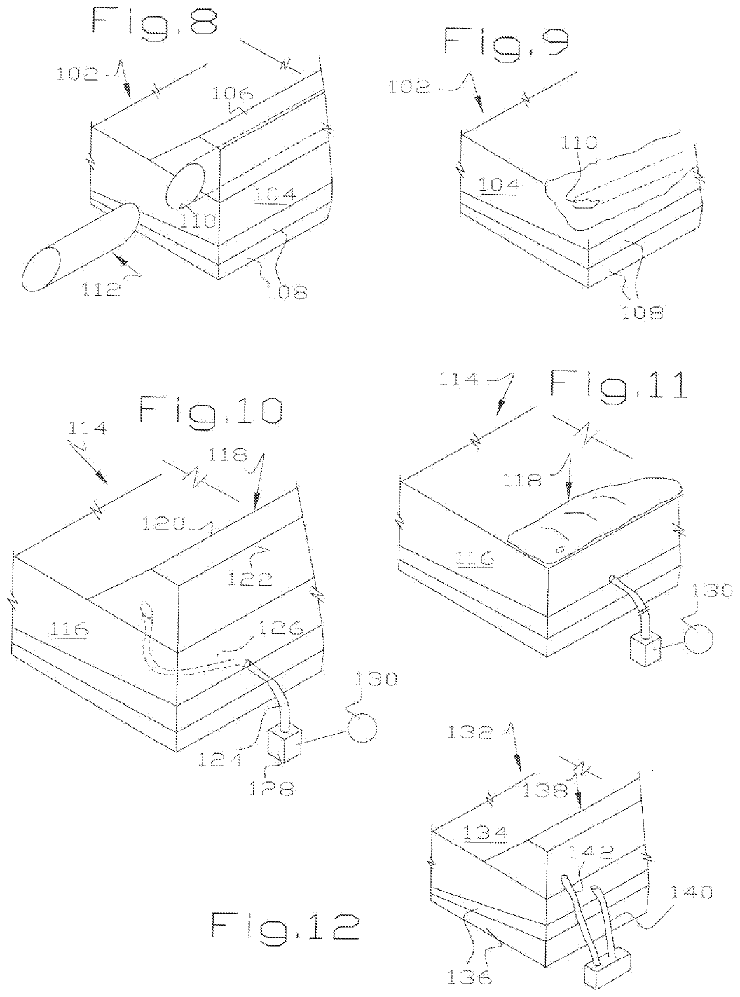

Although the embodiment shown in FIGS. 1, 3 and 4 is effective to reduce the height of the side rails and thereby facilitate lifting a user out of the bed 10, the arrangement of FIGS. 8 and 9 not only reduces the height of the side rail but also reduces the height of the main body support. A mattress 102 accordingly may include a base support 104, a side rail 106 and one or move removable wedges 106. In the process of manufacture, a large passage 110 is formed to span the junction between the base support 104 and the side rail 108 and the base support 104 and side rail 106 are then joined. In order to maximize the size of the passage 110, it may be of non-circular shape, such as oval, and may extend into the base support 104 to maintain a suitable thickness of material between the passage 110 and the exterior of the side rail 106. An insert 112 of any suitable type is inserted into the passage 110 to make the mattress 102 structurally sound and may be removed to partly collapse the side rail 106 and part of the base support 104. This lowers the side of the mattress 102 as well as partly collapsing the side rail 106.

FIGS. 10 and 11 illustrate another technique for alternately providing a structurally sound side rail which may be partly collapsed to facilitate lifting a user over the side rail. A mattress 114 includes a base support 116 of suitable material, such as an open cell foam, and a side rail 118. The side rail 118 is an inflatable structure having seams or other strengthening lines 120, 122 to provide a rail similar in shape to the rails 28, 30, 32, 34. A hose 124 extends through a passage 126 between the interior of the side rail 118 and a control assembly 128 connecting the hose 124 to a source of pressure 130. Pressuring up on the side rail 118 provides sufficient strength to constrain a user in the mattress 114 while exhausting the pressurized fluid from the side rail 118 allows it to partly or totally collapse as shown in FIG. 11.

Referring to FIG. 12, a mattress 132 is illustrated which may be more-or-less completely inflatable. The mattress 132 may comprise a base support 134, one or more wedge shaped sections 136, and a side rail 138. The support 134 and sections 136 may communicate internally of the mattress 132 and be inflated together with a single fluid supplying conduit 140. The side rail 138 may be inflatable separately by a conduit 142 so the side rail 138 may be collapsed to allow the user to be lifted off the mattress 132. The conduits 140, 142 connect to a manifold 144 having control valves (not shown) therein. The manifold 144 connects to a source of pressure to inflate the mattress 132 in any suitable sequence.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I claim:

1. A bed comprising
a wedge shaped torso supporting section;
a wedge shaped leg supporting section; and
a pair of side rails fixed to the torso supporting section;
at least one of the side rails including a member configured to increase a cross-sectional size of the one side rail;
at least one of the side rails being of open foam material and including a passage extending into the open foam material, an insert in the passage providing structural support to the open foam material, the passage and insert being configured to collapse the side rail upon removal.

2. The bed of claim 1 further comprising
a pair of side rails on the leg supporting section,
at least one of the side rails on the leg supporting section including a member configured to increase a cross-sectional size of the one side rail on the leg supporting section;
at least one of the side rails on the leg supporting section being of open foam material and including a passage extending into the open foam material of the leg supporting section, an insert in the passage providing structural support to the open foam material of the leg supporting section, the passage and insert being configured to collapse the open foam material of the leg supporting section upon removal.

3. The bed of claim 2 wherein the wedge shape torso section comprises a first wedge shaped foam member, the wedge shaped leg supporting section comprises a second wedge shaped foam member fixed to the first wedge shaped foam member, the wedge shaped torso section including a third wedge shaped foam member unconnected to and supporting the first wedge shaped foam member, the wedge shaped leg supporting section including a fourth wedge shaped foam member unconnected to and supporting the second wedge shaped form member.

4. The bed of claim 2 wherein the member configured to increase the cross-sectional size of the side rail of the leg supporting section comprises an inflatable member and further comprising a equipment configured to add and withdraw a fluid from the inflatable member.

5. The bed of claim 2 wherein the side rail includes a pocket and the member configured to increase the cross-sectional size of the side rail of the leg supporting section includes a wedge inserted into the pocket.

6. The bed of claim 1 wherein the passage is generally cylindrical and the insert comprises a cylinder.

7. The bed of claim 1 where the insert comprises an inflatable member.

8. The bed of claim 1 wherein the member configured to increase the cross-sectional size of the torso supporting member comprises an inflatable member and further comprising equipment configured to add and withdraw a fluid from the inflatable member.

9. The bed of claim 1 wherein the side rail includes a pocket and the member configured to increase the cross-sectional size of the side rail of the leg supporting section includes a wedge inserted into the pocket.

10. The bed of claim 1 wherein the passage is generally cylindrical and the insert comprises a cylinder.

11. The bed of claim 1 where the insert comprises an inflatable member.

12. A bed comprising a wedge shaped torso supporting section, a wedge shaped leg supporting section, and a pair of side rails on the torso supporting section, at least one of the side rails including a member configured to increase a cross-sectional size of the one side rail.

13. The bed of claim 12 wherein the member configured to increase the cross-sectional size of the side rail of the leg supporting section comprises an inflatable member and further comprising equipment configured to add and withdraw a fluid from the inflatable member.

14. The bed of claim 12 wherein the one side rail includes a pocket and the member configured to increase the cross-sectional size of the side rail of the leg supporting section includes a wedge inserted into the pocket.

15. A bed comprising a wedge shaped torso supporting section, a wedge shaped leg supporting section and a pair of side rails on the torso supporting section, at least one of the side rails being of open foam material and including a passage extending into the open foam material, an insert in the passage providing structural support to the open foam material, the passage and insert being configured to collapse the side rail upon removal of the insert.

16. The bed of claim 15 wherein the passage is generally cylindrical and the insert comprises a cylinder.

17. The bed of claim 15 wherein the insert comprises an inflatable member.

18. The bed of claim 15 wherein the insert is of a cylinder of foam material having a cover of material having a coefficient of friction lower than the foam material.

19. The bed of claim 15 wherein the wedge shaped torso member is of an open foam material, the at least one side rail abuts the open foam material of the wedge shaped torso member along a dividing line between the at least one side rail and the wedge shaped torso member and the passage intersects the dividing line, and the insert straddles the dividing line and abuts the wedge shaped torso member and the at least one side rail, the passage and the insert being configured to collapse the at least one side rail and part of the wedge shaped member below the side rail upon removal.

20. The bed of claim 19 wherein the passage is of non-circular shape.
